(19) United States
(12) Patent Application Publication
(10) Pub. No.: US 2026/0135316 A1
(43) Pub. Date: May 14, 2026

(54) ELECTRICAL CONNECTOR WITH IMPROVED TERMINALS

(71) Applicant: FOXCONN INTERCONNECT TECHNOLOGY LIMITED, Grand Cayman (KY)

(72) Inventors: FANG-JWU LIAO, New Taipei (TW); Jia-Hau Liu, New Taipei (TW)

(21) Appl. No.: 19/378,869

(22) Filed: Nov. 4, 2025

(30) Foreign Application Priority Data
Nov. 9, 2024 (CN) 202411595960.7

(51) Int. Cl. H01R 13/24

(52) U.S. Cl. CPC H01R 13/245

(57) ABSTRACT

An electrical connector includes an insulating housing and plural terminals retained in the housing, each terminal has a main portion, an upper elastic portion, an upper contacting portion, and an upper abutting portion extending upward sequentially from the main portion, and a lower elastic portion, a lower contacting portion, and a lower abutting portion extending downward sequentially from the main portion; the main portion has a first side face facing the upper abutting portion and the lower abutting portion; and when the upper contacting portion and the lower contacting portion are pressed, the upper abutting portion abuts against a lower position of the first side face and the lower abutting portion abuts against an upper position of the first side face and the upper abutting portion and the lower abutting portion contact with each other.

### BACKGROUND OF THE INVENTION

### Field of the Invention

The present invention relates to an electrical connector.

### Description of Related Arts

China Patent Publication No. 119324331 discloses a terminal of an electrical connector. The terminal includes a main portion, an upper elastic arm extending upward from the main portion, and a lower elastic arm extending downward from the main portion. The upper elastic arm includes an upper abutting portion inclining from an upper contacting portion toward the main portion and the lower elastic arm includes a lower abutting portion inclining from a lower contacting portion toward the main portion. The upper abutting portion contacts an upper support portion protruding from the main portion, and the lower abutting potion contacts a lower support portion protruding from the main portion when the upper elastic arm and the lower elastic arm are pressed, thereby getting multiple transmission paths within the terminal. As a transmission rate of current electrical connectors is getting higher and higher, how to add transmission path is significant.

Therefore, it is desired to provide an electrical connector with improved terminals.

### SUMMARY OF THE INVENTION

An object of the present invention is to provide an electrical connector with improved terminals.

To achieve the above object, an electrical connector comprises: an insulating housing having an upper face, a lower face, and a plurality of terminal grooves penetrating the upper face and the lower face; and a plurality of terminals retained in corresponding terminal grooves; wherein each of the terminals comprises a main portion, an upper elastic portion, an upper contacting portion, and an upper abutting portion extending upward sequentially from the main portion, and a lower elastic portion, a lower contacting portion, and a lower abutting portion extending downward sequentially from the main portion, the upper abutting portion extends downward from the upper contacting portion, and the lower abutting portion extends upward from the lower contacting portion; the main portion has a first side face facing the upper abutting portion and the lower abutting portion; and when the upper contacting portion and the lower contacting portion are pressed, the upper abutting portion abuts against a lower position of the first side face of the main portion and the lower abutting portion abuts against an upper position of the first side face of the main portion and the upper abutting portion and the lower abutting portion contact with each other.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of an embodiment of this invention, only one terminal and part of an insulating housing are shown;

FIG. 2 is a perspective view of the terminal in FIG. 1;

FIG. 3 is another perspective view of the terminal in FIG. 2;

FIG. 4 is a right side elevational view of the terminal in FIG. 2;

FIG. 5 is a rear elevational view of the terminal in FIG. 2;

FIG. 6 is a perspective view of the terminal in FIG. 2 when the terminal is pressed;

FIG. 7 is another perspective view of the terminal in FIG. 6;

FIG. 8 is a rear elevational view of the terminal in FIG. 6; and

FIG. 9 is a rear elevational view of the terminal in two states when the terminal is free and pressed respectively.

### DETAILED DESCRIPTION OF THE PREFERRED EMBODIMENT

Reference will now be made in detail to the preferred embodiments of the present invention.

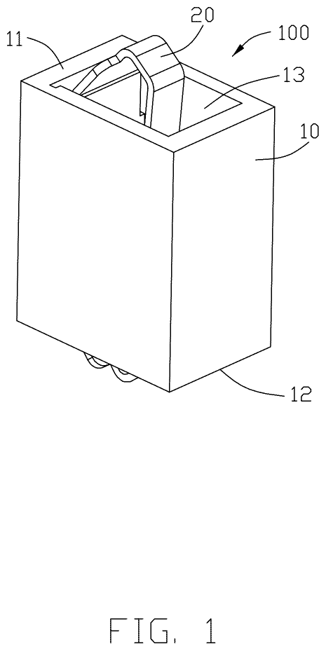

Referring to FIG. 1, an electrical connector 100 of a preferred embodiment is used for electrically connecting a chip module to a circuit board. The electrical connector is alternatively used for connecting two circuit boards. The electrical connector 100 includes an insulating housing 10 and a plurality of terminals 20. The insulating housing 10 has an upper face 11, a lower face 12 and plural terminal grooves 13 penetrating the upper face 11 and the lower face 12 in an upper-lower direction. The terminals 20 are retained in the corresponding terminal grooves 13 one by one. In the embodiment, only one terminal 20 and one corresponding terminal groove 13 are shown. The electrical connector 100 after made has hundreds terminals 20 that are arranged in matrix.

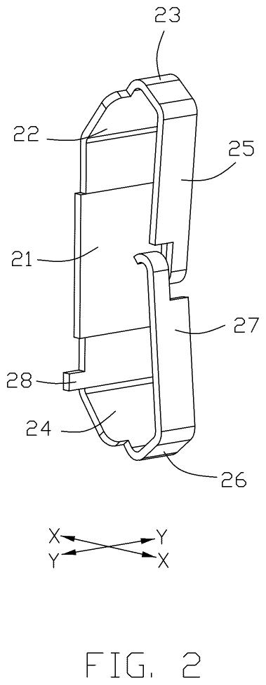

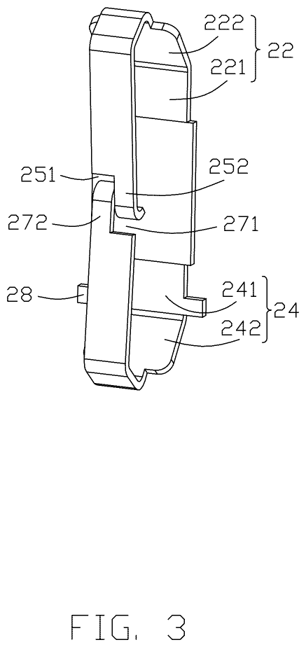

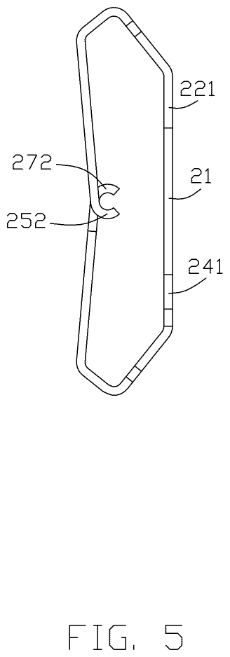

Referring to FIGS. 2-3 and 5-6, the terminals 20 are integrally formed by stamping and bending from a metal plate. Each terminal 20 includes a main portion 21 fixed in the terminal groove 13, an upper elastic arm extending upward from the main portion 21 and a lower elastic arm extending downward from the main portion 21. The upper elastic arm includes an upper elastic portion 22, an upper contacting portion 23 and an upper abutting portion 25 extending upward sequentially from the main portion 21. The lower elastic arm comprises a lower elastic portion 24, a lower contacting portion 26 and a lower abutting portion 27 extending downward sequentially from the main portion 21. The main portion 21 has a first/inner side face 210 adjacent to/facing to the upper abutting portion 25 and the lower abutting portion 27. The lower abutting portion 27 contacts with an upper portion of the first side face 210 and the upper abutting portion 25 contacts with a lower portion of the first side face 210, synchronously, the upper abutting portion 25 and the lower abutting portion 27 contact with each other when the upper elastic arm and the lower elastic arm are pressed.

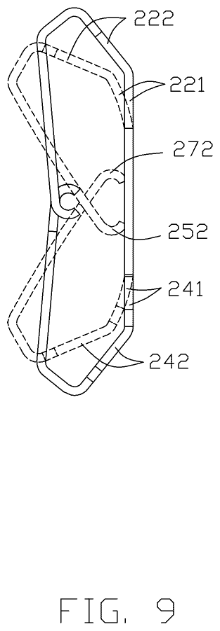

Referring to FIGS. 2-3, 6, and 9, in the embodiment, the upper elastic portion 22 includes a first elastic portion 221 and a second elastic portion 222, and the lower elastic portion 24 includes a first elastic portion 241 and a second elastic portion 242. The main portion 21 and the two first elastic portions 221, 241 are located in a same vertical plane. That is, the upper elastic arm and lower elastic arm are located at a same side of the main portion in a first direction X-X perpendicular to the main portion 21, or at a right side of main portion in a left-right direction as shown FIG. 2. The terminal has a width in a second direction Y-Y perpendicular to the first direction X-X and the upper-lower direction.

A width of the main portion 21 in the second direction is greater than a width of the first elastic portion 221, 241 and a width of the second elastic portion 222, 242. The second elastic portion 222 extends obliquely and upward from the first elastic portion 221 and the second elastic portion 242 extends obliquely and downward from the first elastic portion 241. The upper contacting portion 23 is located at an end of the second elastic portion 222 away from the first elastic portion 221 and the lower contacting portion 26 is located at an end of the second elastic portion 242 away from the first elastic portion 241. The upper abutting portion 25 extends obliquely downward from the upper contacting portion 23 toward the first side face 210 of the main portion 21 and the lower abutting portion 27 extends obliquely upward from the lower contacting portion 26 toward the first side face 210 of the main portion 21. The terminal 20 further includes two strip connecting portions 28 located at two side edges of the lower elastic portion 24 respectively in the second direction Y-Y and the strip connecting portions 28 are proximate to the junction of the first elastic portion 241 and the second elastic portion 242.

Referring to FIGS. 2-5, when the terminal is in a free state without being pressed, the upper abutting portion 25 and lower abutting portion 27 are overlapped in the upper-lower direction and in the second direction to make them crossed. The upper abutting portion and lower abutting portion move in a predetermined path to contact the main portion when the upper and lower contacting portions are pressed. Synchronously, the upper abutting portion and the lower abutting portion also contact with each other in the upper-lower direction. Preferably, the upper abutting portion 25 has an upper notch 251 located at one side edge in the second direction Y-Y proximate to a distal free end thereof and an upper protruding portion 252 located on the other edge thereof. The lower abutting portion 27 has a lower notch 271 located at one side edge in the second direction Y-Y proximate to a distal free end thereof and a lower protruding portion 272 located at the other side edge thereof. The lower protruding portion 272 is located in the upper notch 251 so that the lower protruding portion 272 passes through the upper notch 251 and extends obliquely toward the main portion 21. Similarly, the upper protruding portion 252 is located in the lower notch 271, so that the upper protruding portion 252 passes through the lower notch 271 and extends obliquely toward the main portion 21. That is, one side edge of the free end of the upper abutting portion 25 forms the upper notch 251, leaving the remainder as the upper protruding portion 252, the upper protruding portion 252 is narrower than the upper abutting portion 25. Similarly, one side edge of the free end of the lower abutting portion 27 forms the lower notch 271, leaving the reminder as the lower protruding portion 272. The lower protruding portion 272 and the upper notch 251 are located at a same side in the second direction, the upper protruding portion 271 and the lower notch 252 are at a same side in the second direction but opposite to the lower protruding portion 27. The upper abutting portion 25 and the lower abutting portion 27 are disposed in a cross form in front of the first side face 210 of the main portion 21 in the first direction.

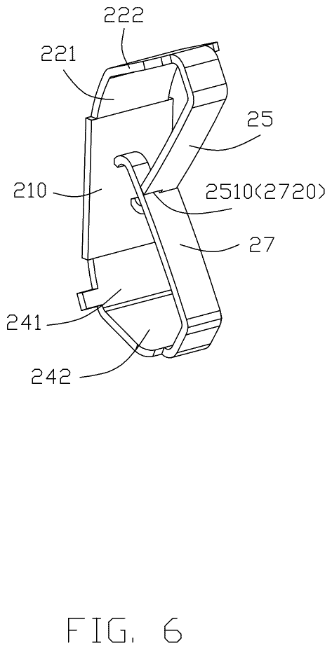

Referring to FIGS. 6-8, the first elastic portions 221, 241 bend and deform when the upper elastic arm 22 and the lower elastic arm 24 are pressed. As the upper abutting portion 25 and the lower abutting portion 27 are crossed in front of the right side face 210 in the first direction, the upper abutting portion 25 and lower abutting portion 27 can move in a predetermined path, making the lower protruding portion 272 contact with the upper position of the first side face 210 and the upper protruding portion 252 contact with the lower position of the first side face 210. The upper protruding portion 252 and the lower protruding portion 272 have a spoon-shaped free end to facilitate the movement of the upper abutting portion 25 and lower abutting portion 27 in the predetermined direction.

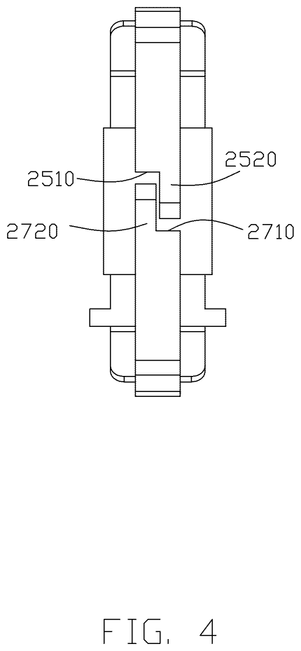

Referring to FIGS. 4 and 6, in the embodiment, it is preferred that the upper notch 251 has an upper edge 2510 and an inner edge 2512, and the lower notch 271 has a lower edge 2710 and an inner edge 2712. When the upper elastic arm 22 and lower elastic arm 24 are pressed, the upper edge 2510 abuts against a second/outer side face 2720 of the lower protruding portion 272, and the lower edge 2710 abuts against a second/outer side face 2520 of the upper protruding portion 252. The second/outer side face 2520, 2720 are away from the first side face 210. The upper abutting portion 25 and lower abutting portion 27 not only contact with the first side face 210 but also contact with each other when the upper elastic arm and lower elastic arm are pressed. Thus, four internal contacting points are formed. With more internal contacting points, the terminal has an excellent conductivity, additionally, the unique crossing structure design of the upper elastic arm and lower elastic arm ensures a stable support when the terminal 20 is pressed into a working state. In the embodiment, to facilitate a smooth insertion of the upper protruding portion 252 into the lower notch 271 and the lower protruding portion 272 into the upper notch 251, both the upper notch 251 and the lower notch 271 are rectangular and the inner edge 2512 of the upper notch 251 (the inner edge of the upper protruding portion 252) and the inner edge 2712 of the lower notch 271 (the inner edge of the lower protruding portion 272) are spaced apart.

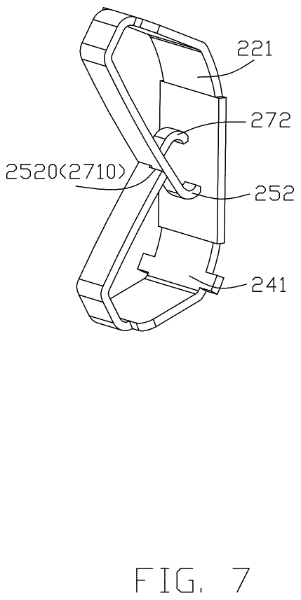

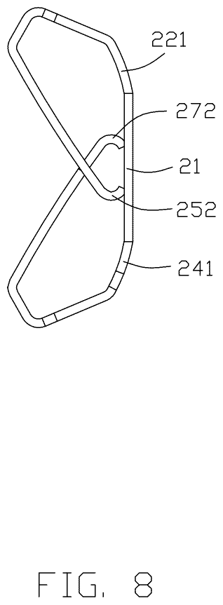

In other embodiments, the contact points between the upper abutting portion 25 and the lower abutting portion 27 can be achieved in other ways when the upper elastic arm and the lower elastic arm are pressed. For example, in other embodiment as shown in FIGS. 7-8, the upper abutting portion 25 and the lower abutting portion 27 can be designed in an arc or arc-like shape. The free ends of both the upper abutting portion 25 and lower abutting portion 27 contact with the first side face 210 when the upper elastic arm and the and lower elastic arm are pressed. Different from the first embodiment, the free end of the upper abutting portion 25 contacts the upper position of the first side face 210 and the free end of the lower abutting portion 27 contacts the lower position of the first side face 210. Additionally, the second side faces of the upper abutting portion 25 and the lower abutting portion 27 abut against with each other in the upper-lower direction, and the pressed terminal appears to be a B-shape.

In other embodiments, similar to the first embodiment, the upper abutting portion 25 and the lower abutting portion 27 are arranged in a crossing configuration in front of the first side face 210, and the free end of the upper abutting portion 25 contacts the lower position of the first side face 210 and the free end of the lower abutting portion 27 contacts the upper position of the first side face 210 when the upper elastic arm and the lower elastic arm are pressed. The difference lies in that the contact between the upper abutting portion 25 and lower abutting portion 27 is achieved through the mutual contact of an inner edge of the upper abutting portion 25 and inner edge of the lower abutting portion 27 that are close to each other. In other words, the contact between the upper abutting portion 25 and the lower abutting portion 27 is not made along the upper-lower direction but rather through the mutual contact of the inner edge of the upper abutting portion 25 and inner edge of the lower abutting portion 27 that are close to each other. For example, the upper abutting portion 25 and the lower abutting portion 27 can be slightly offset in the second direction, similar to the upper protruding portion 252 and the lower protruding portion 272, and thus, the inner edge of the upper abutting portion 25 and the inner edge of the lower abutting portion 27 that are close to each other come into mutual contact when the upper elastic arm 22 and lower elastic arm 24 are pressed.

In other embodiments, the main portion 21 has an upper support portion and a lower support portion protruding rightward. When the upper elastic arm 22 and lower elastic arm 24 are pressed, the free end of the upper abutting portion 25/the upper protruding portion 252 contacts the upper support portion, and the free end of the lower abutting portion 27/the lower protruding portion 272 contacts the lower support portion.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing having an upper face, a lower face, and a plurality of terminal grooves penetrating the upper face and the lower face; and
a plurality of terminals retained in corresponding terminal grooves; wherein
each of the terminals comprises a main portion, an upper elastic portion, an upper contacting portion, and an upper abutting portion extending upward sequentially from the main portion, and a lower elastic portion, a lower contacting portion, and a lower abutting portion extending downward sequentially from the main portion, the upper abutting portion extends downward from the upper contacting portion, and the lower abutting portion extends upward from the lower contacting portion;
the main portion has a first side face facing the upper abutting portion and the lower abutting portion; and
when the upper contacting portion and the lower contacting portion are pressed, the upper abutting portion abuts against a lower position of the first side face of the main portion and the lower abutting portion abuts against an upper position of the first side face of the main portion and the upper abutting portion and the lower abutting portion contact with each other.

2. The electrical connector as claimed in claim 1, wherein the upper abutting portion has an upper notch and an upper protruding portion located at two side edges at a free end thereof respectively, the lower abutting portion has a lower notch and a lower protruding portion located at two side edges at a free end thereof respectively, the lower protruding portion goes through the upper notch and the upper protruding portion goes through the lower notch to contact the first side face of the main portion.

3. The electrical connector as claimed in claim 2, wherein:
the upper notch has an upper edge and a first inner edge, the lower notch includes a lower edge and a second inner edge; and
when the upper contacting portion and lower contacting portion are pressed, the upper edge abuts against an outer side face of the lower protruding portion and the lower edge abuts against an outer side face of the upper protruding portion, the outer side faces of the lower protruding portion and the upper protruding portion are away from the main portion.

4. The electrical connector as claimed in claim 2, wherein the free ends of the upper protruding portion and lower protruding portion are spoon-shaped.

5. The electrical connector as claimed in claim 1, wherein the upper abutting portion and lower abutting portion are crossed when the terminal is in a free state, thereby the upper abutting portion and the lower abutting portion moving in a predetermined path to contact with the first side face of the main portion.

6. The electrical connector as claimed in claim 1, wherein the terminal further includes two strip connecting portions, the strip connecting portions are located at two side edges of the lower elastic portion respectively.

7. An electrical connector comprising:
an insulating housing having an upper face, a lower face, and at least one terminal groove penetrating the upper face and the lower face; and
a plurality of terminals retained in corresponding terminal grooves respectively; wherein
each of the terminals comprises a main portion, an upper elastic arm extending upward from the main portion, and a lower elastic arm extending downward from the main portion;
the upper elastic arm comprises an upper elastic portion and an upper contacting portion and an upper abutting portion extending sequentially from the main portion, and the lower elastic arm comprises a lower elastic portion and a lower contacting portion and a lower abutting portion extending sequentially from the main portion;
the upper abutting portion inclines toward a first side face of the main portion from the upper contacting portion, and the lower abutting portion inclines toward the first side face of the main portion from the lower contacting portion; and
when the upper elastic arm and the lower elastic arm are pressed, the upper abutting portion and the lower abutting portion come to contact with the main portion and come to contact with each other synchronously.

8. The electrical connector as claimed in claim 7, wherein:
the upper abutting portion and the lower abutting portion are crossed when the terminal is in a free state; and
when the upper elastic arm and the lower elastic arm are pressed, the lower abutting portion contacts an upper position of the first side face, the upper abutting portion contacts a lower position of the first side face, and the upper abutting portion and lower abutting portion abut against with each other.

9. The electrical connector as claimed in claim 8, wherein a free end of the upper abutting portion has an upper notch and an upper protruding portion, a free end of the lower abutting portion has a lower notch and a lower protruding portion, and the upper protruding portion goes through the lower notch and the lower protruding portion goes through the upper notch in a first direction perpendicular to the first side face of the main portion.

10. The electrical connector as claimed in claim 7, wherein the plurality of terminals are integrally formed by stamping from a metal plate.

11. An electrical connector comprising
an insulating housing having an upper face, a lower face, and a plurality of terminal grooves penetrating the upper face and the lower face; and
a plurality of terminals retained in corresponding terminal grooves, each of the terminals comprising a main portion, an upper elastic arm extending upward from the main portion, and a lower elastic arm extending downward from the main portion; wherein
the upper elastic arm comprises an upper elastic portion, an upper contacting portion, and an upper abutting portion extending from the main portion sequentially, the lower elastic arm comprises a lower elastic portion, a lower contacting portion, and a lower abutting portion extending from the main portion sequentially, the upper abutting portion extends downward from the upper contacting portion and toward a first side face of the main portion, and the lower abutting portion extends upward from the lower contacting portion and toward the first side face of the main portion; and
the upper abutting portion and the lower abutting portion come to contact with each other and come to contact the first side face of the main portion synchronously when the upper elastic arm and the lower elastic arm are pressed.

12. The electrical connector as claimed in claim 11, wherein the terminals are integrally formed by stamping from a metal plate.

13. The electrical connector as claimed in claim 11, wherein each of the upper elastic portion and the lower elastic portion comprises a first elastic portion extending from the main portion and a second elastic portion extending from the first elastic portion, and the first elastic portions and the main portion are in a same vertical plate when the terminal is in a free state.
